(19) United States
(12) Patent Application Publication
(10) Pub. No.: US 2014/0205919 A1
(43) Pub. Date: Jul. 24, 2014

(54) GAS DIFFUSION LAYER WITH IMPROVED ELECTRICAL CONDUCTIVITY AND GAS PERMEABILITY AND PROCESS OF MAKING THE GAS DIFFUSION LAYER

(71) Applicants: FUTURE CARBON GMBH, Bayreuth (DE); SGL CARBON SE, Wiesbaden (DE)

(72) Inventors: PETER WILDE, MEITINGEN (DE); RUEDIGER SCHWEISS, MEITINGEN (DE); STEFAN FORERO, WEIDENBERG (DE); MELANIE HABERKORN, HAAG (DE); TIM SCHUBERT, BAYREUTH (DE)

(73) Assignees: FUTURE CARBON GMBH, Bayreuth (DE); SGL CARBON SE, Wiesbaden (DE)

(21) Appl. No.: 14/221,525

(22) Filed: Mar. 21, 2014

Related U.S. Application Data
(63) Continuation of application No. PCT/EP2012/067536, filed on Sep. 7, 2012.

(30) Foreign Application Priority Data
Sep. 21, 2011 (DE) 102011083118.5

(51) Int. Cl. H01M 4/86; H01M 4/04; H01M 8/10; H01M 4/88; C25B 11/03; H01M 4/66

(52) U.S. Cl. CPC H01M 4/8626; C25B 11/035; H01M 4/663; H01M 8/1004; H01M 4/8807; H01M 4/0404
USPC 429/406; 429/534; 204/284; 429/245; 429/480; 427/122

(57) ABSTRACT

A gas diffusion layer contains a substrate formed of a carbon containing material and a micro porous layer. The gas diffusion layer can be obtained by dispersing carbon black with a BET surface area of at most 200 m²/g, carbon nanotubes with a BET surface area of at least 200 m²/g and with an average outer diameter of at most 25 nm and a dispersion medium at a shearing rate of at least 1,000 seconds⁻¹ and/or such that, in the dispersion produced, at least 90% of all carbon nanotubes have a mean agglomerate size of at most 25 μm. The dispersion is applied to at least one portion of at least one side of the substrate, and the dispersion is dried.

### CROSS-REFERENCE TO RELATED APPLICATION

This is a continuation application, under 35 U.S.C. §120, of copending international application No. PCT/EP2012/067536, filed Sep. 7, 2012, which designated the United States; this application also claims the priority, under 35 U.S.C. §119, of German patent application No. 10 2011 083 118.5, filed Sep. 21, 2011; the prior applications are herewith incorporated by reference in their entirety.

### BACKGROUND OF THE INVENTION

### Field of the Invention

The present invention relates to a gas diffusion layer, a method for producing such a gas diffusion layer, the use of such a gas diffusion layer, a gas diffusion electrode, and the use of such a gas diffusion electrode.

Gas diffusion layers and gas diffusion electrodes of such kind are used in many different applications, particularly in fuel cells, in electrolytic cells and batteries. Fuel cells are electrochemical cells that have been suggested for example as a propulsion source to replace the internal combustion engine in motor vehicles. When a fuel cell is operated, a fuel such as hydrogen or methanol is reacted electrochemically with an oxidant, usually air, in the presence of a catalyst, yielding water when hydrogen is the fuel, and water and carbon dioxide when methanol is the fuel. For this purpose, polymer electrolyte membrane (PEM) fuel cells contain a membrane electrode assembly (MEA) that consists of a thin, proton-permeable, electrically non-conductive, solid polymer electrolyte membrane, in which an anode catalyst is disposed on one of the sides of the membrane, and a cathode catalyst is disposed on the opposite side of the membrane. When a PEM fuel cell is operated, protons and electrons are released from the fuel at the anode, and these react with oxygen at the cathode to form water. As the protons are transported from the anode through the polymer electrolyte membrane to the cathode, the electrons migrate from the anode to the cathode through an external circuit. The voltage that is created between the anode and cathode may be used to drive an electric motor for example.

In order to ensure that gas is transported efficiently, and above all constantly in the fuel cell, specifically that the reactant gases are transported efficiently and constantly, hydrogen to the anode and oxygen to the cathode, a porous gas diffusion medium or gas diffusion layer (GDL) is usually provided on both opposite sides of the MEA. The side of each of these gas diffusion layers that is farthest from the MEA is in contact with a bipolar plate that separates the fuel cell from adjacent fuel cells. Apart from ensuring efficient, uniform transport of the reactant gases to the electrodes, the gas diffusion layers are also responsible for ensuring that the water formed in the fuel cell as a product of the reaction is removed from the fuel cell. The gas diffusion layers also serve as current collectors and conductors, transporting the electrons released at the anode to the corresponding bipolar plate, and out of the fuel cell through the plate, and feeding electrons to the cathode via the bipolar plate arranged on the other side of the fuel cell. In order to be able to perform these functions, a gas diffusion layer must have the highest possible electrical conductivity and high gas permeability.

Such gas diffusion layers are typically composed of porous carbon fiber paper or carbon fiber fleece. In order to prevent the pores of the gas diffusion layer from being flooded with water when the fuel cell is in operation, which would entirely prevent gas from being transported in the gas diffusion layer, at least the side of the gas diffusion layer facing the MEA is usually configured to be hydrophobic, for example by coating the side with a hydrophobic substance, or by impregnating the gas diffusion layer with a hydrophobic substance. In addition, a micro porous layer (MPL) that enhances the transport of water inside the fuel cell and electrically couples the gas diffusion layer to the adjacent catalyst layer, thereby increasing both the performance and the service life not only of the gas diffusion layer, but also of the fuel cell is conventionally provided on the side of the carbon fiber paper or the carbon fiber fleece facing the MEA. Such micro porous layers usually consist of a mixture of carbon black and a hydrophobic polymer, such as polytetrafluoroethylene, wherein the carbon black creates the electrical conductivity and the hydrophobic polymer is intended to prevent the gas diffusion layer from being flooded with water. Such a micro porous layer is typically prepared by depositing a dispersion containing carbon black, a hydrophobic polymer and water as the dispersion medium on the substrate made of carbon fiber paper or carbon fiber fleece, and then drying to remove the dispersion medium. In order to improve the properties of the micro porous layer, it has previously been suggested to add carbon nanotubes or carbon nanofibers to the mixture of carbon black and hydrophobic polymer. In order to be able to fulfil its functions, the level of the electrical conductivity and gas permeability of the micro porous layer must also be as high as possible.

However, the currently known gas diffusion layers and in particular the micro porous layers thereof need to be improved, particularly with respect to the electrical conductivity and gas permeability thereof. It is difficult to improve both of these properties at the same time due to the fact that the gas permeability and electrical conductivity of such a layer do not correlate with each other, but on the contrary an improvement in gas permeability, by increasing porosity for example, generally entails a reduction in electrical conductivity, and conversely an increase in electrical conductivity typically causes a reduction in the gas permeability. In order to be used as a propulsion source in a vehicle, the current densities of 1.5 A/cm² that are presently achieved by fuel cells must be increased to more than 2 A/cm². At the same time, the loading of the catalyst layers with the expensive catalyst material, conventionally platinum, must be reduced to lower the costs of fuel cells to an acceptable level. Particularly with high current densities, however, the output of a fuel cell is limited primarily by its electrical resistance and by the mass transport of the reactant gases to the catalyst layers. Consequently, the necessary increase in current density and the reduction of catalyst loading can only be achieved by increasing both the electrical conductivity and the gas permeability of the gas diffusion layers.

### SUMMARY OF THE INVENTION

The object of the present invention is therefore to provide a gas diffusion layer that has increased electrical conductivity and at the same time is characterized by greater gas permeability.

According to the invention, the object is achieved with a gas diffusion layer containing a substrate of carbon-containing material and a micro porous layer. The gas diffusion layer is obtainable in a process that has the following steps:
i) dispersing carbon black with a BET surface area of at most 200 m²/g, carbon nanotubes with a BET surface area of at least 200 m²/g and an average outer diameter (d₅₀) of at most 25 nm and a dispersion medium-containing mixture with a shearing rate of at least 1,000 rps and/or such that in the dispersion produced, at least 90% of the carbon nanotubes have a mean agglomerate size of at most 25 μm,
ii) applying the dispersion produced in step i) to at least a portion of at least one side of the substrate, and
iii) drying the dispersion applied in step ii) in order to remove at least some of the dispersion medium, thereby forming the micro porous layer.

The solution is based on the surprising discovery that a combination of first using specific carbon black, namely carbon black having a comparatively low specific surface area, second using specific carbon nanotubes, namely carbon nanotubes having a comparatively high specific surface area and a comparatively low average outer diameter, and third having a comparatively high degree of homogenization of the carbon black, carbon nanotubes, and dispersion medium-containing mixture used to prepare the micro porous layer dispersion. A gas diffusion layer containing a micro porous layer is obtained that compared to the currently known gas diffusion layers not only has greater electrical conductivity, but is also characterized particularly by improved gas permeability. In this context, the three measures described in the preceding operate in a surprisingly synergistic manner. It is important for the purposes of the invention that the carbon black, carbon nanotubes and the dispersion medium-containing mixture is dispersed with a shearing rate of at least 1,000 rps and/or in such manner that at least 90% of all the carbon nanotubes contained in the dispersion thus produced have an average agglomerate size of at most 25 μm, that is to say to some degree the carbon black and the carbon nanotubes are dispersed in parallel. This surprisingly results in a gas diffusion layer containing a micro porous layer having greater electrical conductivity and greater gas permeability than a corresponding process performed with the same raw materials, in which, instead of the aforementioned parallel dispersion, first a dispersion of carbon black in a dispersion medium and second a dispersion of carbon nanotubes in a dispersion medium are produced separately without homogenization that is to say without the application of high shearing forces—before the two dispersions are mixed together, or in which first a dispersion of carbon nanotubes is prepared in dispersion medium, and then carbon black is added to the dispersion medium without further homogenization, that is to say without the application of high shearing forces. Without wishing to be bound by a given theory, it is thought that this may be caused by the situation in which the parallel dispersion of carbon black and carbon nanotubes with a sufficiently high shearing rate not only enables the carbon black and carbon nanotubes to be mixed thoroughly as required, but in the micro porous layer in particular with regard to a porosity that increases gas permeability and improved electrical conductivity an optimal alignment is achieved between the individual carbon nanotubes and the individual carbon black particles as well as an optimum size of the carbon nanotube agglomerates. Thus, overall, an excellent boundary surface structure of the individual particles in the micro porous layer results from the combination of the specific carbon black, the specific carbon nanotubes and the parallel dispersion, which in turn results in improved electrical conductivity and at the same time improved gas permeability of the gas diffusion layer. In particular, the parallel dispersion also enables a greater quantity of carbon nanotubes to be introduced into the dispersion, and thus also into the micro porous layer, since, when produced in separate dispersions, that is to say in a method in which first a dispersion of carbon black in dispersion medium and second a dispersion of carbon nanotubes in dispersion medium are produced separately before the two dispersions are mixed with one another without homogenization, instead of by the aforementioned parallel dispersion, the corresponding quantities of carbon nanotubes are limited due to the sharp increase in viscosity in the dispersions as the quantities of carbon black and carbon nanotubes are increased. Based on the preceding advantageous properties, the gas diffusion layer according to the invention is particularly suitable for use in a fuel cell that is operated at a high current density of over 1.5 A/cm² and in particular over 1.6 A/cm².

In accordance with the usual definition of this parameter, for the purposes of the present invention an average outer diameter (d₅₀) of the carbon nanotubes is understood to be the value for the outer diameter below which 50% of the carbon nanotubes under consideration fall, that is, 50% of all the carbon nanotubes present have an outer diameter smaller than the d₅₀ value. The average outer diameter of the carbon nanotubes is measured by transmission electron microscopy (TEM). In this process, at least 3 TEM images of different areas of the sample are produced and evaluated, and the outer diameter of at least 10 carbon nanotubes is determined for each TEM image, and the overall outer diameter of at least 50 carbon nanotubes is determined on the three TEM images. A size distribution is then determined from the individual values obtained in this way, and the average outer diameter is calculated from this.

In addition, the mean agglomerate size of the carbon nanotubes is determined according to the present invention over a frequency range from 1 to 100 MHz using a DT-1201 acoustic spectrometer manufactured by Quantachrome GmbH.

According to a further preferred embodiment of the present invention, a mixture is dispersed in process step i), which contains relative to the carbon content of the mixture, that is to say relative to the combined quantities of carbon black and carbon nanotubes and any other carbon contained 10 to 50% by weight, preferably 20 to 40% by weight, particularly preferably 25 to 35% by weight, and most preferably about 30% by weight of carbon nanotubes. In this way, excellent electrical conductivity is achieved at a cost that is still acceptable.

According to the invention, the carbon black particles used to prepare the micro porous layer of the gas diffusion layer according to the invention have a BET surface area of at most 200 m²/g. Particularly good results, particularly with respect to electrical conductivity, are achieved, when the carbon black particles have a BET surface area from 20 to 100 m²/g and preferably from 40 to 80 m²/g.

In a refinement of the invention it is suggested to use carbon black having an average particle diameter (d₅₀) from 30 to 100 nm in step i).

The mixture used in the process step i) preferably contains—relative to the carbon content of the mixture—50 to 90% by weight, preferably 60 to 80% by weight, and particularly preferably 65 to 75% by weight carbon black—relative to the carbon content of the mixture. It is particularly preferred that the mixture used in process step i) contains no other carbon than the carbon black and the carbon nanotubes, that is to say the mixture consists of from 50 to 90% by weight carbon black and from 10 to 50% by weight carbon nanotubes relative to the carbon content of the mixture—preferably from 60 to 80% weight carbon black and from 20 to 40% by weight carbon nanotubes, and particularly preferably from 65 to 75% by weight carbon black and 25 to 35% by weight of carbon nanotubes.

According to a further preferred embodiment of the present invention, a mixture is dispersed in process step i), in which the combined quantities of carbon black and carbon nanotubes are equal to 1 to 15% by weight, preferably 2 to 12% by weight, and particularly preferably 4 to 8% by weight relative to the total quantity of mixture. As was explained in the preceding, the mixture used in process step i) contains no carbon other than the carbon black and the carbon nanotubes, so that in this way particularly preferably the carbon content of the mixture is preferably 1 to 15% by weight, particularly preferably 2 to 12% by weight, and most preferably 4 to 8% by weight relative to the total quantity of the mixture.

In general, any liquids that are suitable for dispersion of carbon black and carbon nanotubes and that do not dissolve and/or decompose the carbon black or the carbon nanotubes may be used as the dispersion medium. Only the alcohols thereof, such as methanol, ethanol, propanol, butanol, pentanol and the like, water or mixtures of water and alcohol(s) are cited, water being the dispersion medium that is particularly preferred.

In principle, the present invention is not limited with regard to the quantity of dispersion medium used in process step i). Good results are obtained particularly when the quantity of the dispersion medium used in process step i), particularly water, is equal to 50 to 98% by weight, preferably 85 to 95% by weight, more preferably 87 to 94% by weight and most preferably about 89% by weight relative to the total quantity of the mixture.

In order to lend hydrophobic properties to the micro porous layer of the gas diffusion layer according to the invention, particularly to reliably prevent flooding of the micro porous layer with water when the gas diffusion layer is used in a PEM fuel cell, for example, in a development of the invention thought it is suggested that the mixture applied to the substrate in process step ii) should further contain a binding agent. The binding agent may be contained in the mixture used in step i), that is to say before the shearing speed is applied, or added to the mixture that is dispersed in step i), that is to say the mixture after dispersion—i.e., after the shearing speed has been applied—but before process step ii) is carried out. In general, all hydrophobic substances that are compatible with carbon black and carbon nanotubes may be used as binding agents. Good results are obtained for example with fluoropolymers, and especially perfluoropolymers. Polytetrafluoroethylene is used especially preferably as the binding agent.

In general, the present invention is not limited with regard to the quantity of binding agent used in process step i). Good results are obtained particularly when the quantity of binding agent used in step i) particularly polytetrafluoroethylene, is equal to 0.1 to 10% by weight, preferably 0.5 to 5% by weight, particularly preferably 1 to 3.5% by weight, and most preferably about 1.3% by weight relative to the total quantity of the mixture.

Besides the carbon black, the carbon nanotubes, the dispersion medium and the optional binding agent, the mixture that is applied to the substrate in process step ii) may also contain one or more film forming substances. For this purpose, the mixture used in process step, that is to say the mixture that exists before the shear mixing is applied may contain one or more film forming substances. Alternatively, one or more film-forming substances can be added to the already dispersed mixture, that is to say the mixture that exists after dispersion—and as such the mixture after the shear mixing is applied—but before the performance of process step ii). Particularly suitable film forming substances include polyalkylene glycols such as polyethylene glycols, for example polyethylene glycol 400. In addition to or instead of the film-forming substance, the mixture that is applied to the substrate in process step ii) may contain one or more viscosity adjusters, that is to say one or more viscosity adjusters may be contained in the mixture that is used in process step i) or added to the already dispersed before the performance of process step ii). Polysaccharides and preferably cellulose or cellulose derivatives function particularly well as viscosity adjusters. In this regard, good results are obtained particularly when the mixture applied to the substrate in step ii) of the method contains hydroxypropyl cellulose as the viscosity adjuster.

According to a preferred embodiment of the present invention, the mixture applied to the substrate in process step ii) contains:
1 to 15% by weight of the total of carbon black and carbon nanotubes, wherein the carbon black has a BET surface area of at most 200 m²/g, the carbon nanotubes have a BET surface area of at least 200 m²/g and an average outer diameter (d₅₀) of at most 25 nm, the quantity of carbon nanotubes is 10 to 50% by weight relative to the carbon content of the mixture, and the balance to 100% by weight of the carbon content is carbon black,
50 to 98% by weight dispersion medium,
0.1 to 10% by weight binding agent,
0 to 5% by weight film forming substance, and
0 to 5% by weight hydroxypropyl cellulose as the viscosity adjuster.

The mixture applied in process step ii) particularly preferably contains:
1 to 12% by weight of the total of carbon black and carbon nanotubes, wherein the carbon black has a BET surface area of at most 200 m²/g, the carbon nanotubes have a BET surface area of at least 200 m²/g and an average outer diameter (d₅₀) of not more than 25 nm, the quantity of carbon nanotubes is 20 to 40% by weight relative to the carbon content of the mixture, and the balance to 100% by weight of the carbon content is carbon black,
85 to 95% by weight dispersion medium,
0.5 to 5% by weight binding agent,
to 4% by weight film forming substance, and
0.5 to 2.5% by weight hydroxypropyl cellulose as the viscosity adjuster.

Very particularly preferably, the mixture applied in process step ii) contains:
4 to 8% by weight of the total of carbon black and carbon nanotubes, wherein the carbon black has a BET surface area of 20 to 100 m²/g, the carbon nanotubes have a BET surface area of 210 to 300 m²/g and an average outer diameter (d₅₀) of 10 to less than 20 nm, the quantity of carbon nanotubes is 25 to 35% by weight relative to the carbon content of the mixture, and the balance to 100% by weight of the carbon content is carbon black,
87 to 94% by weight water as the dispersion medium,
1 to 3% by weight polytetrafluoroethylene as the binding agent,
1 to 4% by weight polyethylene glycol as the film forming substance, and
0.5 to 2% by weight hydroxypropyl cellulose as the viscosity adjuster.

Of course, the totals of the components of each of the three mixtures listed above are equal to 100% by weight.

Other features which are considered as characteristic for the invention are set forth in the appended claims.

Although the invention is described herein as embodied in a gas diffusion layer with improved electrical conductivity and gas permeability and a process for making the gas diffusion layer, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DETAILED DESCRIPTION OF THE INVENTION

As was described above in detail, it is an important feature of the present invention that the gas diffusion layer according to the invention is obtainable by a method in which a micro porous layer on a substrate is formed from carbon-containing material by applying and drying a mixture containing carbon black, carbon nanotubes and a dispersion medium. The mixture has been dispersed before application thereof to the substrate by subjecting it to a shearing speed of at least 1,000 rps and/or has been dispersed in such manner that at least 90% of all carbon nanotubes in the prepared dispersion have an average agglomerate size not greater than 25 μm. This parallel dispersion of the carbon black and the carbon nanotubes surprisingly results in production of a gas diffusion layer containing a micro porous layer having greater electrical conductivity and greater gas permeability than with a corresponding process carried out using the same raw materials, in which instead of parallel dispersion first a dispersion of carbon black in a dispersion medium and second a dispersion of carbon nanotubes in a dispersion medium are produced separately from one another and then the two dispersions are mixed together without homogenization that is to say without the application of shearing forces, or in which first a dispersion of carbon nanotubes is prepared in dispersion medium, and then carbon black is added to the dispersion medium without further homogenization that is to say without the application of shearing forces. In this context, particularly good results are obtained if the mixture is dispersed in step i) by the application of a shearing speed of at least 2,000 rps and preferably at least 5,000 rps.

Similarly, it is preferred that the mixture is dispersed in process step i) in such manner that at least 90% of all the carbon nanotubes contained in the dispersion thus prepared have an average agglomerate size from 0.5 to less than 20 μm, and preferably from 0.5 to less than 15 μm. Most preferably, the mixture is dispersed in step i) in such manner that at least 95% of all the carbon nanotubes contained in the dispersion thus prepared have an average agglomerate size from 0.5 to less than 20 μm, and preferably from 0.5 to less than 15 μm. Most particularly preferably, the mixture is dispersed in step i) in such manner that all of the carbon nanotubes contained in the dispersion thus prepared have an average agglomerate size from 0.5 to less than 20 μm, and preferably from 0.5 to less than 15 μm.

For dispersion of the above mixture with a shearing speed of at least 1,000 rps and/or in such manner that at least 90% of the carbon nanotubes in the dispersion thus prepared have an agglomerate size not exceeding 25 μm, suitable devices include for example ball mills, bead mills, sand mills, kneaders, roller mills, static mixers, ultrasonic dispersers, apparatuses that exert high pressures, high accelerations and/or high impact shearing forces, and any combination of two or more of the aforementioned devices.

In this context, the dispersive mixture used in step i) may be manufactured in a variety of ways. On the one hand, the carbon nanotubes may first be dispersed in the dispersion medium by applying a shearing speed of at least 1,000 rps, for example, before adding carbon black to the dispersion and dispersing the mixture thus obtained at a shearing speed of at least 1,000 rps and/or in such manner that at least 90% of all the carbon nanotubes in the dispersion produced thereby have an agglomerate size not exceeding 25 μm. Alternatively, the carbon nanotubes may first be stirred into the dispersion medium without applying any significant shearing speed, before carbon black is added to this mixture and the mixture thus obtained is dispersed at a shearing speed of at least 1,000 rps and/or is dispersed in such manner that at least 90% of all the carbon nanotubes in the dispersion produced thereby have an agglomerate size not exceeding 25 μm. Alternatively, the carbon black may first be stirred into the dispersion medium without applying any significant shearing speed, before the carbon nanotubes are added to this mixture and the mixture thus obtained is dispersed at a shearing speed of at least 1,000 rps and/or is dispersed in such manner that at least 90% of all the carbon nanotubes in the dispersion produced thereby have an agglomerate size not exceeding 25 μm. The additives listed previously, that is to say binding agents, film forming substances and/or viscosity adjusters, may each be added to the dispersed mixtures or to individual components of the mixture before the dispersion is carried out.

In process step ii) the dispersion prepared in process step i) may be applied to the substrate by any means known to a person skilled in the art. For example, techniques such as spraying, dipping, spreading, rolling, brushing or silk screening are just a few such methods.

With the drying process carried out in process step iii), the dispersion is adhered to the substrate surface, and at the same time, at least part of the dispersion medium is removed. The drying in process step iii) is preferably carried out at a temperature from 40 to 150° C., particularly preferably from 50 to 130° C., very particularly preferably from 60 to 100° C., and most preferably from 70 to 90° C., for example at 80° C. Drying continues until a sufficient amount of the dispersion medium has been removed, preferably for a period from 5 minutes to 2 hours and particularly preferably for a period from 10 to 30 minutes.

In a development of the inventive idea it is suggested to sinter the dried gas diffusion layer in a subsequent step iv), wherein the sintering is preferably carried out for 1 to 60 minutes at a temperature above 150° C. Particularly good results are obtained if sintering is carried out for 2 to 30 at a temperature from 200 to 500° C., and in particular for 5 to 20 minutes, for example 10 minutes, at a temperature from 325 to 375° C., for example about 350° C.

During sintering, any additives contained in the dispersed mixture, for example the film forming substance, particularly polyethylene glycol, and the viscosity adjuster, particularly hydroxypropyl cellulose, are at least almost completely decomposed, so that after sintering a micro porous layer containing the carbon black, the carbon nanotubes and the optional binding agent remains. According to a preferred embodiment of the present invention, the dried and optionally sintered micro porous layer of the gas diffusion layer according to the invention contains 50 to 99.9% by weight of the total of carbon black having the above-mentioned BET surface area and carbon nanotubes with the above-mentioned BET surface area, and the aforementioned average outer diameter, with the balance to 100% by weight of a binding agent, wherein the quantity of carbon nanotubes relative to the carbon content of the micro porous layer is 10 to 50% by weight. Particularly preferably, the dried and optionally sintered micro porous layer of the gas diffusion layer according to the invention contains 70 to 99% by weight of the total of carbon black having the above-mentioned BET surface area and carbon nanotubes with the above-mentioned BET surface area, and the aforementioned average outer diameter, with the balance to 100% by weight of a binding agent, wherein the quantity of carbon nanotubes relative to the carbon content of the micro porous layer is 20 to 40% by weight. Most particularly preferably, the dried and optionally sintered micro porous layer of the gas diffusion layer according to the invention contains 75 to 95% by weight and especially preferably 77 to 90% by weight of the total of carbon black having the above-mentioned BET surface area and carbon nanotubes with the above-mentioned BET surface area, and the aforementioned average outer diameter, with the balance to 100% by weight of a binding agent, wherein the quantity of carbon nanotubes relative to the carbon content of the micro porous layer is 25 to 35% by weight.

In a development of the inventive idea it is suggested that the dried and optionally sintered micro porous layer of the gas diffusion layer according to the invention has porosity from 30 to 50% and preferably from 35 to 45%, measured by mercury porosimetry in accordance with DIN 66133.

It is further preferred that the dried and optionally sintered micro porous layer of the gas diffusion layer according to the invention has an average pore diameter (d50) 0.05 to 1 μm, and preferably from 0.25 to 0.5 μm.

All porous, carbon-containing materials that are conventionally used as the substrate for a gas diffusion layer may serve as the carbon-containing substrate. Good results are obtained in particular if the substrate is selected from the group consisting of carbon fiber nonwovens, carbon fiber papers, carbon fiber fabrics, and any mixtures thereof.

According to a further preferred embodiment of the present invention, the substrate is at least partially coated with a hydrophobic substance, or preferably impregnated therewith, for render the substrate hydrophobic. In this context, fluoropolymers and particularly preferably perfluoropolymers, in particular polytetrafluoroethylene, are suitable for use as the hydrophobic substance. Particularly good results are obtained, for example, if the substrate, for example a carbon nonwoven, is impregnated with polytetrafluoroethylene with a loading of 5% by weight, for example.

In a further development of the inventive idea, it is suggested that the gas diffusion layer has an electrical resistance of less than 8 Ω·cm², preferably less than 7 Ω·cm² and most preferably less than 6 Ω·cm² under compression of 100 N/cm².

It is further preferable that the gas diffusion layer, has a Gurley gas permeability greater than 2 cm³/cm²/s, preferably greater than 3 cm³/cm²/s, and particularly preferably greater than 4 cm³/cm²/s, as measured according to DIN ISO 5636/5, ASTM D-726-58.

Another object of the present invention is a gas diffusion layer that contains a substrate of carbon-containing material and a micro porous layer, wherein:
a) the micro porous layer is composed of 50 to 99.9% by weight, preferably 70 to 99% by weight, particularly preferably 75 to 95% by weight, and most preferably 77 to 90% by weight in total of carbon black and carbon nanotubes, with the balance to 100% by weight of a binding agent, wherein the carbon black has a BET surface area not exceeding 200 m²/g, the carbon nanotubes have a BET surface area of at least 200 m²/g and an average outer diameter (d₅₀) of at most 25 nm, and the quantity of carbon nanotubes relative to the carbon content of the micro porous layer is 10 to 50% by weight, preferably 20 to 40% by weight, and particularly preferably 25 to 35% by weight,
b) the gas diffusion layer has an electrical resistance less than 8 Ω·cm² under compression of 100 N/cm², and
c) the gas diffusion layer has a Gurley gas permeability greater than 2 cm³/cm²/s.

The electrical resistance of the gas diffusion layer under compression of 100 N/cm² is preferably less than 7 Ω·cm², and particularly preferably less than 6 Ω·cm².

It is further preferred that the Gurley gas permeability of the gas diffusion layer is greater than 3 cm³/cm²/s³, and particularly preferably greater than 4 cm³/cm²/s.

It is further preferred that the binding agent is polytetrafluoroethylene.

The present invention further relates to a gas diffusion electrode containing a gas diffusion layer as described above, wherein a catalyst layer is disposed on the micro porous layer. The catalyst layer may be for example a layer of metal, particularly a layer of precious metal, such as platinum film, or it may consist of metal particles, particularly, precious metal particles, such as platinum particles, supported on a substrate such as carbon particles.

A further object of the present invention is a process for preparing a gas diffusion layer described in the preceding, containing the following steps:
i) dispersing a carbon black having a BET surface area of at most 200 m²/g, carbon nanotubes having a BET surface area of at least 200 m²/g and having an average outer diameter (d₅₀) of at most 25 nm, and a dispersion medium by applying a shearing speed of least 1,000 rps, and/or in such manner that at least 90% of all the carbon nanotubes in the prepared dispersion of have an average agglomerate size not exceeding 25 μm,
ii) applying the dispersion produced in step i) to at least a portion of at least one side of the substrate,
iii) drying the dispersion applied in step ii) at a temperature between 40 and 150° C., and
iv) optionally, sintering the dried gas diffusion layer at a temperature of higher than 150° C.

The present invention further relates to the use of a gas diffusion layer described in the preceding, or a gas diffusion electrode as described in the preceding, in a fuel cell, an electrolytic cell or a battery, and preferably in a polymer electrolyte membrane fuel cell, a direct methanol fuel cell, a zinc-air battery or a lithium-sulphur battery.

In the following, the present invention will be explained with the aid of an exemplary embodiment thereof, provided solely for illustrative purposes and without limitation thereto.

10 g carbon nanotubes with a BET surface area of 263 m²/g and an average outer diameter (d₅₀) of 15 nm, and 30 g carbon black having a BET surface area of 62 m²/g (Super P manufactured by Timcal Graphite & Carbon's , USA) were dispersed for 10 minutes in 490 g at a shearing speed of 5,000 rps. Approximately 90% of all the carbon nanotubes present in the dispersion obtained thereby had an average agglomerate size not exceeding 20 μm. The dispersion (530 g) was mixed with 150 g more water, 20 g polyethylene glycol 400, 9 g hydroxypropyl cellulose and 16 g polytetrafluoroethylene dispersion having a polytetrafluoroethylene content of 59% by weight (Dyneon T5050 manufactured by 3M), and was homogenized for 15 minutes with a vane agitator mixer at a speed of less than 200 rpm.

The dispersion thus prepared was applied with a doctor blade in a quantity of about 16 g/m² to carbon fiber paper (Sigracet GDL 25BA manufactured by SGL Carbon GmbH) that had been impregnated with 5% by weight polytetrafluoroethylene, and then dried at 80° C. for 10 minutes. The dried gas diffusion layer was then sintered at 350° C. for 10 minutes.

A gas diffusion layer was obtained that had an electrical resistance of 6.1 Ω·cm² measured under compression of 100 N/cm² and gas permeability of 5.9 cm³/cm²/s as determined by the Gurley method. The gas diffusion medium had a specific pore volume of 3.5 cm³/g, a porosity of 39.7% and a most frequent pore diameter of 0.35 μm.

1. A process for forming a gas diffusion layer having a substrate of a carbon-containing material and a micro porous layer, which comprises the steps of:
i) dispersing carbon black with a BET surface area of at most 200 m²/g, carbon nanotubes with a BET surface area of at least 200 m²/g and an average outer diameter of at most 25 nm and a dispersion medium at a shearing rate of at least 1,000 rps and/or such that in a mixture produced of the carbon black, the carbon nanotubes and the dispersion medium, at least 90% of the carbon nanotubes have a mean agglomerate size of at most 25 μm;
ii) applying the mixture produced in step i) to at least a portion of at least one side of the substrate; and
iii) drying the mixture applied in step ii).

2. The process according to claim 1, which further comprises forming the carbon nanotubes used in step i) to have an average outer diameter from 8 to 25 nm.

3. The process according to claim 1, which further comprises providing the carbon nanotubes used in step i) with a BET surface area of more than 200 to 400 m²/g.

4. The process according to claim 1, which further comprises forming the mixture used in step i) to contain 10 to 50% by weight of the carbon nanotubes relative to a carbon content of the mixture.

5. The process according to claim 1, which further comprises forming the carbon black used in step i) to have a BET surface area of 20 to 100 m²/g.

6. The process according to claim 1, which further comprises forming the dispersion medium used in step i) from water, wherein a quantity of the dispersion medium relative to a total quantity of the mixture is 50 to 98% by weight.

7. The process according to claim 1, wherein the mixture applied in step ii) consists of:
1 to 15% by weight of a total of the carbon black and the carbon nanotubes, wherein the carbon black has a BET surface area of at most 200 m²/g, the carbon nanotubes have a BET surface area of at least 200 m²/g and an average outer diameter of at most 25 nm, a quantity of the carbon nanotubes is 10 to 50% by weight relative to a carbon content of the mixture, and a balance to 100% by weight of the carbon content is the carbon black, 50 to 98% by weight water as the dispersion medium, 0.1 to 10% by weight polytetrafluoroethylene as a binding agent, 0 to 5% by weight polyethylene glycol as a film forming substance, and 0 to 5% by weight hydroxypropyl cellulose as a viscosity adjuster.

8. The process according to claim 1, which further comprises dispersing the mixture in step i) at a shearing speed of at least 5,000 rps.

9. The process according to claim 1, which further comprises dispersing the mixture in step i) in such manner that at least 90% of the carbon nanotubes contained in the mixture prepared thereby have an average agglomerate size of 0.5 to less than 20 μm.

10. The process according to claim 1, which further comprises performing step ii) in a ball mill, a bead mill, a sand mill, a kneader, a roller mill, a static mixer, an ultrasonic disperser, an apparatus that exerts high pressures, high accelerations and/or high impact shearing forces, and any combination of at least two of the above mentioned devices.

11. The process according to claim 1, wherein the gas diffusion layer has an electrical resistance of less than 8 Ω·cm² under compression of 100 N/cm².

12. The process according to claim 1, which further comprises:
forming the micro porous layer to be 50 to 99.9% by weight in total of the carbon black and the carbon nanotubes, with a balance to 100% by weight of a binding agent, wherein the carbon black has a BET surface area not exceeding 200 m²/g, the carbon nanotubes have a BET surface area of at least 200 m²/g and an average outer diameter of at most 25 nm, and a quantity of the carbon nanotubes relative to a carbon content of the micro porous layer is 10 to 50% by weight;
forming the gas diffusion layer to have an electrical resistance less than 8 Ω·cm² under compression of 100 N/cm²; and
forming the gas diffusion layer with a Gurley gas permeability greater than 2 cm³/cm²/s.

13. A gas diffusion electrode, comprising:
a gas diffusion layer having a substrate of a carbon-containing material and a micro porous layer, said gas diffusion layer formed by the steps of:
i) dispersing carbon black with a BET surface area of at most 200 m²/g, carbon nanotubes with a BET surface area of at least 200 m²/g and an average outer diameter of at most 25 nm and a dispersion medium at a shearing rate of at least 1,000 rps and/or such that in a mixture produced of said carbon black, said carbon nanotubes and said dispersion medium, at least 90% of said carbon nanotubes have a mean agglomerate size of at most 25 μm;
ii) applying said mixture produced in step i) to at least a portion of at least one side of said substrate; and
iii) drying the mixture applied in step ii); and
a catalyst layer disposed on said micro porous layer.

14. A process for producing a gas diffusion layer containing a substrate of a carbon-containing material and a micro porous layer, the process comprises the steps of i) dispersing carbon black having a BET surface area of at most 200 m²/g, carbon nanotubes having a BET surface area of at least 200 m²/g and having an average outer diameter of at most 25 nm, and a dispersion medium by applying a shearing speed of least 1,000 rps and/or in such manner that at least 90% of all the carbon nanotubes in a mixture of the carbon black, the carbon nanotubes and the dispersion medium have an average agglomerate size not exceeding 25 μm;
ii) applying the mixture produced in step i) to at least a portion of at least one side of the substrate;
iii) drying the mixture applied in step ii) at a temperature between 40 and 150° C.; and
iv) sintering the gas diffusion layer at a temperature higher than 150° C.

15. A gas diffusion layer, comprising:
a substrate of a carbon-containing material; and
a micro porous layer disposed on said substrate, said micro porous layer containing:
i) a mixture of carbon black with a BET surface area of at most 200 m²/g, carbon nanotubes with a BET surface area of at least 200 m²/g and an average outer diameter of at most 25 nm and a dispersion medium, said mixture dispersed at a shearing rate of at least 1,000 rps and/or such that in said mixture produced, at least 90% of said carbon nanotubes have a mean agglomerate size of at most 25 μm;
said mixture applied to at least a portion of at least one side of said substrate; and
said mixture is dried.

16. The gas diffusion layer according to claim 15, wherein:
said carbon nanotubes have an average outer diameter from 8 to 25 nm;
said carbon nanotubes have a BET surface area of more than 200 to 400 m²/g;
said mixture contains 10 to 50% by weight of said carbon nanotubes relative to a carbon content of said mixture; and
said carbon black having a BET surface area of 20 to 100 m²/g.

17. The gas diffusion layer according to claim 15, wherein:
said dispersion medium includes water, wherein a quantity of said dispersion medium relative to a total quantity of said mixture is 50 to 98% by weight;
said mixture includes 1 to 15% by weight of a total of said carbon black and said carbon nanotubes, wherein said carbon black has a BET surface area of at most 200 m²/g, said carbon nanotubes have a BET surface area of at least 200 m²/g and said average outer diameter of at most 25 nm, a quantity of said carbon nanotubes is 10 to 50% by weight relative to a carbon content of said mixture, and a balance to 100% by weight of said carbon content is said carbon black, 0.1 to 10% by weight polytetrafluoroethylene as a binding agent, 0 to 5% by weight polyethylene glycol as a film forming substance, and 0 to 5% by weight hydroxypropyl cellulose as a viscosity adjuster; and
said mixture is dispersed at a shearing speed of at least 5,000 rps.

18. The gas diffusion layer according to claim 15, wherein:
at least 90% of said carbon nanotubes contained in said mixture have an average agglomerate size of 0.5 to less than 20 μm; and
the gas diffusion layer has an electrical resistance of less than 8 Ω·cm² under compression of 100 N/cm².

19. The gas diffusion layer according to claim 15, wherein:
said micro porous layer has 50 to 99.9% by weight in total of said carbon black and said carbon nanotubes, with a balance to 100% by weight of a binding agent, wherein said carbon black has a BET surface area not exceeding 200 m²/g, said carbon nanotubes have a BET surface area of at least 200 m²/g and an average outer diameter of at most 25 nm, and a quantity of said carbon nanotubes relative to a carbon content of said micro porous layer is 10 to 50% by weight;
the gas diffusion layer has an electrical resistance less than 8 Ω·cm² under compression of 100 N/cm²; and
the gas diffusion layer has a Gurley gas permeability greater than 2 cm³/cm²/s.

20. An energy storing device selected from the group consisting of a fuel cell, an electrolytic cell, a battery, a polymer electrolyte membrane fuel cell, a direct methanol fuel cell, a zinc-air battery and a lithium-sulphur battery, the energy storing device comprising:
a gas diffusion layer, containing:
a substrate of a carbon-containing material; and
a micro porous layer disposed on said substrate, said micro porous layer including:
i) a mixture of carbon black with a BET surface area of at most 200 m²/g, carbon nanotubes with a BET surface area of at least 200 m²/g and an average outer diameter of at most 25 nm and a dispersion medium, said mixture dispersed at a shearing rate of at least 1,000 rps and/or such that in said mixture produced, at least 90% of said carbon nanotubes have a mean agglomerate size of at most 25 μm;
said mixture applied to at least a portion of at least one side of said substrate; and
said mixture is dried.
